(19) United States
(12) Patent Application Publication
(10) Pub. No.: US 2026/0031361 A1
(43) Pub. Date: Jan. 29, 2026

(54) NEGATIVE ELECTRODE FOR SECONDARY BATTERY, SECONDARY BATTERY, AND MANUFACTURING METHOD FOR NEGATIVE ELECTRODE FOR SECONDARY BATTERY

(71) Applicant: Prime Planet Energy & Solutions, Inc., Tokyo (JP)

(72) Inventor: Harumi MASUI, Kobe-shi (JP)

(21) Appl. No.: 19/258,897

(22) Filed: Jul. 3, 2025

(30) Foreign Application Priority Data
Jul. 24, 2024 (JP) 2024-118863

(51) Int. Cl. H01M 4/62; H01M 4/04; H01M 4/133; H01M 4/1393; H01M 4/36; H01M 4/587

(52) U.S. Cl. CPC H01M 4/628; H01M 4/0404; H01M 4/133; H01M 4/1393; H01M 4/364; H01M 4/587

(57) ABSTRACT

A negative electrode for a secondary battery disclosed herein includes a negative electrode current collector and a negative electrode active material layer fixed to the negative electrode current collector. The negative electrode active material layer includes graphite particles and Si-containing particles as a negative electrode active material, and gap keeping particles that exist more around the Si-containing particle than around the graphite particle and keep a gap around the Si-containing particle.

### CROSS REFERENCE TO RELATED APPLICATION

This application claims the benefit of priority to Japanese Patent Application No. 2024-118863 filed on Jul. 24, 2024. The entire contents of this application are hereby incorporated herein by reference.

### BACKGROUND OF THE DISCLOSURE

### 1. Field

The present disclosure relates to a negative electrode for a secondary battery, a secondary battery, and a manufacturing method for the negative electrode for the secondary battery.

### 2. Background

Conventionally, a technique of using Si-containing particles as a negative electrode active material in order to achieve a high-capacity secondary battery has been known (for example, see Japanese Patent Application Publication No. 2014-103052, Japanese Patent No. 7121449, Japanese Patent No. 5637257, and WO 2014/181447).

### SUMMARY

However, the volume change (the amount of expansion and shrinkage) of the Si-containing particle at charging and discharging is larger than that of a graphite particle, which is known as a general negative electrode active material, for example. Therefore, according to the present inventor's examination, an electrolyte solution easily flows out from a negative electrode including the Si-containing particle when the Si-containing particle expands. Thus, in the aforementioned technique, as charging and discharging are performed repeatedly, the electrolyte solution becomes insufficient around the Si-containing particle, that is, so-called liquid shortage occurs easily, which is a problem. Such a problem tends to become apparent particularly in a secondary battery of a high input-output type that is mounted on a mobile body such as a vehicle.

The present disclosure has been made in view of the above circumstances, and a main object is to provide a negative electrode for a secondary battery, including Si-containing particles, in which liquid shortage occurs less easily.

The present disclosure provides a negative electrode for a secondary battery, including a negative electrode current collector and a negative electrode active material layer fixed to the negative electrode current collector. The negative electrode active material layer includes graphite particles and Si-containing particles as a negative electrode active material, and gap keeping particles that exist more around the Si-containing particle than around the graphite particle and keep a gap around the Si-containing particle.

In the present disclosure, a number of gap keeping particles exist (with bias) around the Si-containing particle. Thus, even if the Si-containing particle expands or shrinks at charging and discharging, the gap can be kept around the Si-containing particle and a state in which an electrolyte solution permeates in the gap can be kept. Therefore, the liquid keeping property can be improved around the Si-containing particle and the occurrence of the liquid shortage can be suppressed. Accordingly, a secondary battery in which the battery capacity does not easily decrease even after the high-rate charging and discharging are repeated (a secondary battery that is excellent in high-rate cycle characteristic) can be achieved.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic view illustrating one Si-containing particle and its periphery; and

FIG. 2 is a schematic longitudinal cross-sectional view of a secondary battery according to one embodiment.

### DETAILED DESCRIPTION OF THE PREFERRED EMBODIMENTS

Hereinafter, preferred embodiments of the art disclosed herein will be described. Matters that are other than matters particularly mentioned in the present specification and that are necessary for the implementation of the art disclosed herein (for example, the general configuration and manufacturing process of a secondary battery that do not characterize the art disclosed herein) can be grasped as design matters of those skilled in the art based on the prior art in the relevant field. The art disclosed herein can be implemented on the basis of the disclosure of the present specification and common technical knowledge in the relevant field. Note that in the present specification, the notation “A to B” for a range signifies a value more than or equal to A and less than or equal to B, and is meant to encompass also the meaning of being “preferably more than A” and “preferably less than B”.

### [Negative Electrode for Secondary Battery]

First, a negative electrode for a secondary battery disclosed herein is described. Note that in the present specification, the term “secondary battery” refers to general electrical energy storage devices that are capable of being charged and discharged repeatedly, and corresponds to a concept that encompasses a so-called secondary battery such as a lithium ion secondary battery or a nickel-hydrogen secondary battery, and moreover, a capacitor using a chemical reaction, such as a lithium ion capacitor or a pseudo-capacitor. The negative electrode for a secondary battery disclosed herein is preferably a negative electrode for a nonaqueous electrolyte solution secondary battery and more preferably a negative electrode for a lithium ion secondary battery.

The negative electrode for a secondary battery disclosed herein includes a negative electrode current collector, and a negative electrode active material layer fixed to at least one surface of the negative electrode current collector. The negative electrode active material layer is preferably provided on both surfaces of the negative electrode current collector from the viewpoint of increasing the capacity. The negative electrode current collector is preferably formed of a metal and is more preferably formed of, for example, a conductive metal such as copper, a copper alloy, nickel, or stainless steel. The negative electrode current collector is preferably a metal foil, and for example, more preferably a copper foil or a copper alloy foil. Although there is no particular limitation, the thickness of the metal foil is preferably 5 to 35 μm and more preferably 6 to 20 μm, for example.

The negative electrode active material layer includes at least (1) a negative electrode active material and (2) gap keeping particles. The negative electrode active material layer may further include another optional component. In this embodiment, the negative electrode active material layer further includes (3) a conductive material and (4) a binder. The negative electrode active material layer preferably includes (3) the conductive material and (4) the binder. Each component is hereinafter described in order.
(1) The negative electrode active material is formed of a material that can reversibly store and release charge carriers. In this embodiment, the negative electrode active material necessarily includes (1a) graphite particles and (1b) Si-containing particles. Thus, the characteristics of the battery (for example, capacity increase and high-rate cycle characteristic) can be achieved at a high level.
(1a) The graphite particle is a material whose volume change (amount of expansion and shrinkage) at charging and discharging is smaller than that of (1b) the Si-containing particle. The graphite particle is not limited in particular and may be either natural graphite or artificial graphite, and may be amorphous carbon covering graphite in which a graphite particle, which is a core, is covered with an amorphous carbon material. Although there is no particular limitation, the average particle diameter of the graphite particles is preferably 1 to 100 μm, more preferably 5 to 50 μm, and still more preferably 10 to 30 μm. Note that, in the present specification, the term “average particle diameter” refers to a particle diameter (D50) at a cumulative value of 50% in the particle size distribution based on the volume measured by a particle size distribution measurement device in accordance with a laser diffraction/scattering method.
(1b) The Si-containing particle is a material whose volume change (amount of expansion and shrinkage) at charging and discharging is larger than that of (1a) the graphite particle. The Si-containing particle may be any particle containing Si (silicon) and known as being usable as the negative electrode active material, without particular limitations. Examples thereof include a Si particle, a SiC composite particle, a silicon oxide particle represented by SiOₓ (in which 0.05<x<1.95), a silicon carbide particle represented by SiC_{y} (in which 0<y<1), a silicon nitride particle represented by SiN_{z} (in which 0<z<4/3), and the like. In particular, the SiC composite particle is preferable. The SiC composite particle typically has a structure in which a Si particle is disposed in a pore of a porous skeleton made of carbon.

Although there is no particular limitation, an average particle diameter D1 of the Si-containing particles is preferably smaller than the average particle diameter of the aforementioned graphite particles, and is more preferably ½ or less and still more preferably ⅓ or less of the average particle diameter of the graphite particles. The average particle diameter D1 of the Si-containing particles is preferably 1 to 20 μm, more preferably 3 to 15 μm, and still more preferably 5 to 10 μm.

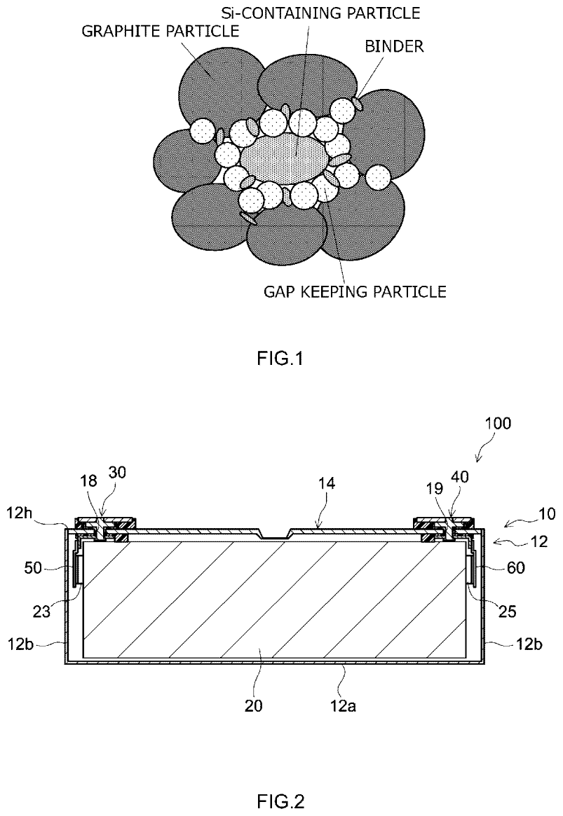

FIG. 1 is a schematic view illustrating one Si-containing particle and its periphery. As illustrated in FIG. 1, in the Si-containing particle, a surface of at least a part thereof is preferably covered with (2) the gap keeping particles to be described below. A coverage b of the Si-containing particle with the gap keeping particles is preferably 50% or more and more preferably 60 to 90%. It is preferable that a half or more of the entire surface of the Si-containing particle be covered with the gap keeping particles, and it is particularly preferable that substantially the whole (80% or more) thereof be covered with the gap keeping particles. Thus, more gaps can be secured around the Si-containing particle and accordingly, the effect of the art disclosed herein can be achieved at a higher level.

In this specification, the term “coverage” means the value obtained in such a way that, for example, outlines of a plurality of particles that are optionally selected are determined in an observation image using an electron microscope such as a scanning electron microscope (SEM), the ratio of the total area of parts of each particle to which the gap keeping particles adhere in the entire surface area is calculated in percentage, and the obtained values are subjected to arithmetic averaging.

Although there is no particular limitation, the mass ratio between (1a) the graphite particles and (1b) the Si-containing particles is preferably graphite particles:Si-containing particles=95:5 to 40:60 and more preferably 90:10 to 60:40. It is preferable that (1) the negative electrode active material contain the graphite particles as a primary component (whose mass ratio is the largest, and this definition applies similarly to the description below) and it is more preferable that the negative electrode active material contain the graphite particles as a main component (whose mass ratio is 50 mass % or more, and this definition applies similarly to the description below).

When the total amount of (1) the negative electrode active material is 100 mass %, the content ratio of (1a) the graphite particles is preferably 50 to 95 mass % and more preferably 60 to 90 mass %. When the total amount of (1) the negative electrode active material is 100 mass %, the content ratio of (1b) the Si-containing particles is preferably 5 to 50 mass % and more preferably 10 to 30 mass %.

From the viewpoint of achieving the effect of the art disclosed herein at the higher level, the total of (1a) the graphite particles and (1b) the Si-containing particles constitutes preferably 80 mass % or more, more preferably 90 mass % or more, and still more preferably 95 mass % or more of the entire negative electrode active material, and the negative electrode active material may substantially be formed of (1a) the graphite particles and (1b) the Si-containing particles (the total of both components may constitute 98 mass % or more).

However, the negative electrode active material may further include another particle that is known to be usable as the negative electrode active material, typically in a content ratio that is smaller than the content ratios of (1a) the graphite particles and (1b) the Si-containing particles. The content ratios of these other particles are preferably 10 mass % or less and more preferably 5 mass % or less of the entire negative electrode active material.
(2) The gap keeping particle is typically a particle that is distinguished from the negative electrode active material. In other words, the gap keeping particle is a particle without a function to reversibly store and release charge carriers (a particle that does not change in volume (expand or shrink) at charging and discharging). In the art disclosed herein, the gap keeping particles are particles existing more (with bias) around (1b) the Si-containing particle than around (1a) the graphite particle and having a function to keep the gap around the Si-containing particle. Thus, even if (1b) the Si-containing particle intensively expands or shrinks at the charging and discharging, the electrolyte solution can be kept in the gap around the Si-containing particle stably and the liquid keeping property of the Si-containing particle can be improved. As a result, the liquid shortage of the Si-containing particle can be suppressed.

In the present specification, “existing more (with bias) around the Si-containing particle than around the graphite particle” means that as illustrated in FIG. 1, more gap keeping particles exist around (1b) the Si-containing particle than around (1a) the graphite particle. In other words, when the coverage of (1a) the graphite particle with the gap keeping particles is a and the coverage of (1b) the Si-containing particle with the gap keeping particles is b, a<b is satisfied.

Although there is no particular limitation, the coverage a is preferably less than 50% and more preferably 10 to 30% from the viewpoint of achieving the effect of the art disclosed herein at the higher level. Moreover, from the viewpoint of achieving the effect of the art disclosed herein at the higher level, the difference (b−a) between the coverage b and the coverage a is preferably 10% or more, more preferably 20% or more, still more preferably 30% or more, and particularly preferably 50% or more. The difference (b−a) between the coverage b and the coverage a may be 80% or less or 70% or less.

From the viewpoint of achieving the effect of the art disclosed herein at the higher level, the ratio (a/b) of the coverage a to the coverage b is preferably 0.8 or less, more preferably 0.75 or less, still more preferably 0.6 or less, and particularly preferably 0.5 or less. The ratio (a/b) is preferably 0.1 or more, more preferably 0.2 or more, and still more preferably 0.25 or more from the viewpoint of securing the excellent conductive path for (1b) the Si-containing particles. Thus, disconnection of the conductive path does not easily occur even after the charging and discharging are repeated, and the irreversible decrease in battery capacity can be suppressed. Note that the ratio (a/b) can be adjusted suitably by mixing at least a part of the Si-containing particles with the gap keeping particles before the graphite particles and by the ratio of the Si-containing particles to be mixed first, which will be described in a manufacturing method (first mixing step) below.

The material and property of the gap keeping particle are not limited in particular as long as the gap can be kept around the Si-containing particle. In some embodiments, the gap keeping particle preferably has a spherical shape with an average aspect ratio (length of long side/length of short side, which similarly applies to the description below) of 1.5 or less. Thus, the gap is easily kept stably between the particles (between the gap keeping particle and the Si-containing particle and/or between the gap keeping particles, which similarly applies to the description below).

The kind of the gap keeping particle is not limited in particular. The gap keeping particle is preferably insoluble in a dispersion solvent used for a negative electrode mixture in the manufacturing method (second mixing step) to be described below. The gap keeping particle may be, for example, an inorganic particle such as a ceramic particle or a metal particle, an organic particle such as a resin particle, or an organic-inorganic composite particle. In particular, the gap keeping particle is preferably an inorganic particle because the hardness and strength are higher than those of the organic particle and deformation due to an external force does not occur easily, for example. Thus, the predetermined gap around (1b) the Si-containing particle is easily kept stably and the cycle characteristic can be improved further. Examples of the ceramic particle include silica, alumina (anhydride), an alumina hydrate (for example, boehmite), titania, zirconia, and the like. In particular, silica is preferable because of being relatively inexpensive and easily obtainable, for example. As the resin particle, for example, cellulose is preferable.

In some embodiments, the gap keeping particles preferably include an insulating particle (for example, ceramic particle or resin particle). Thus, the side reaction with the charge carrier (here, lithium ion) or the electrolyte solution can be reduced. Furthermore, the unintended formation of an SEI film on the surface of the Si-containing particle and the irreversible decrease in battery capacity can be suppressed. However, the gap keeping particles may include a conductive particle.

From the viewpoint of achieving the effect of the art disclosed herein at the higher level, the gap keeping particles preferably include the insulating particle mainly. When the total amount of the gap keeping particles is 100 mass %, the content ratio of the insulating particles is more preferably 80 mass % or more and still more preferably 95 mass % or more, and it is particularly preferable that the gap keeping particles be substantially formed of the insulating particles (98 mass % or more of the gap keeping particles be the insulating particles).

In addition, in some embodiments, it is preferable that the gap keeping particles include a particle that also has a gap inside the particle and can keep the electrolyte solution, for example a porous particle (preferably a continuous porous particle having a pore structure with stereoscopic mesh shapes continuing in the particle) or a hollow particle (a particle having a shell part and a hollow part formed inside the shell part). In particular, the gap keeping particles preferably include the porous particle (for example, ceramic particle). By the inclusion of the porous particle, the gap in which the electrolyte solution permeates can be secured also in the particle; thus, the liquid keeping property around the Si-containing particle can be improved further. However, the gap keeping particles may include a particle that can keep the gap only between the particles, for example a solid particle (particle not having the hollow part) or a non-porous particle.

Although there is no particular limitation, the porosity of the porous particle is preferably 5% or more, more preferably 10% or more, and still more preferably 10 to 60%, for example. In the present specification, the term “porosity” refers to a value obtained in such a way that an outline of an optionally selected particle is determined and the ratio of the total area of gap parts to the area of the entire particle (the sum of the area occupied by the particle and the total area of the gap parts) is calculated in percentage.

From the viewpoint of achieving the effect of the art disclosed herein at the higher level, the gap keeping particles preferably include the porous particle mainly. When the total amount of the gap keeping particles is 100 mass %, the content ratio of the porous particles is more preferably 80 mass % or more and still more preferably 95 mass % or more, and it is particularly preferable that the gap keeping particles be substantially formed of the porous particles (98 mass % or more of the gap keeping particles be the porous particles).

Although there is no particular limitation, a ratio (D2/D1) of an average particle diameter D2 of the gap keeping particles to the average particle diameter D1 of (1b) the Si-containing particles described above is preferably 0.01 to 1, more preferably 0.05 to 0.8, and still more preferably 0.1 to 0.5. Thus, more gaps can be secured around (1b) the Si-containing particles (particularly between the Si-containing particles) and the effect of the art disclosed herein can be achieved at the higher level.

The average particle diameter D2 of the gap keeping particles is not limited in particular because the average particle diameter D2 is preferably defined in accordance with the relation with the average particle diameter D1 of the Si-containing particles; however, the average particle diameter D2 is preferably smaller than the average particle diameter D1 of (1b) the Si-containing particles and is preferably about 0.1 to 10 μm, more preferably 0.4 to 7 μm, about 5 μm or less, for example still more preferably 0.5 to 5 μm, and particularly preferably 0.7 to 3.5 μm.

Although there is no particular limitation, the content ratio of the gap keeping particles is preferably 0.01 to 10 parts by mass, more preferably 0.05 to 8 parts by mass, still more preferably 0.1 to 5 parts by mass, about 3 parts by mass or less, and particularly preferably 0.1 to 3 parts by mass for example, per 100 parts by mass of the negative electrode active material. When the content ratio is the predetermined value or more, more gaps can be secured around the Si-containing particle and the effect of the art disclosed herein can be achieved at the higher level. When the content ratio is the predetermined value or less, disconnection of the conductive path for the Si-containing particle does not easily occur even after the repeated charging and discharging. Thus, the irreversible decrease in battery capacity can be suppressed.

In some embodiments, the content ratio of the gap keeping particles is preferably larger than the content ratio of (3) the conductive material to be described below. In some embodiments, the content ratio of the gap keeping particles is preferably smaller than the content ratio of (4) the binder to be described below.
(3) The conducive material is a component that increases the conductivity in the negative electrode active material layer. In particular, when (2) the gap keeping particles include the insulating particle, it is difficult to obtain the conductive path in the negative electrode active material layer; therefore, it is preferable to include the conductive material. Note that although the illustration of the conductive material is omitted in FIG. 1, the conductive material is preferably disposed uniformly in the negative electrode active material layer. In other words, it is preferable that the conductive material be disposed with balance around (1a) the graphite particle and (1b) the Si-containing particle and do not exist with bias around (1b) the Si-containing particle, unlike (2) the gap keeping particles described above.

The conductive material is not limited in particular and one kind or two or more kinds of materials that are known as being usable for this type of application conventionally can be used without particular limitations. Examples thereof include carbon nanotube (CNT), carbon fiber, carbon nanofiber, carbon black, activated carbon, hard carbon, soft carbon, and other amorphous carbon materials. The conductive material preferably has higher electric conductivity than (2) the gap keeping particle. In particular, CNT is preferably contained because the conductivity is excellent, for example.

CNT is fibrous carbon with a structure in which graphite constituting a carbon hexagonal network is rounded into a tubular shape. CNT may be single-walled carbon nanotube (SWCNT) with a structure in which graphite in one layer is rounded into a tubular shape, double-walled carbon nanotube (DWCNT) with a structure in which graphite in two layers is rounded into a tubular shape, or multi-walled carbon nanotube (MWCNT) with a structure in which graphite in three or more layers is rounded into a tubular shape. CNT may include impurities (for example, catalyst or amorphous carbon) derived from a manufacturing process, for example.

The conductive material preferably has a shape with high anisotropy. In some embodiments, the conductive material preferably includes a carbon material (fibrous carbon) in a fibrous mode with an average aspect ratio of 10 or more. Specifically, it is preferable to include CNT, carbon fiber, carbon nanofiber, or the like. Since the fibrous carbon has excellent conductivity and does not easily aggregate compared to carbon black, which is usually used as the conductive material, for example, the fibrous carbon is easily disposed uniformly in the negative electrode active material layer. The fibrous carbon has an average aspect ratio of preferably 20 or more, more preferably 50 or more, and still more preferably 100 or more.

Although there is no particular limitation, the content ratio of the conductive material is preferably 0.01 to 10 parts by mass, more preferably 0.05 to 5 parts by mass, and still more preferably 0.1 or 2 parts by mass per 100 parts by mass of the negative electrode active material.
(4) The binder is a component that increases the integrity of the negative electrode active material layer. The binder is preferably disposed uniformly in the negative electrode active material layer. In other words, it is preferable that the binder be disposed with balance around (1a) the graphite particle and (1b) the Si-containing particle and do not exist with bias around (1b) the Si-containing particle, unlike (2) the gap keeping particles described above.

The binder is not limited in particular and one kind or two or more kinds of materials that are known as being usable for this type of application conventionally can be used without particular limitations. Examples thereof include rubbers such as styrene butadiene rubber (SBR), celluloses such as carboxymethyl cellulose (CMC), and acrylic resins (resin obtained by polymerizing monomers with an acryloyl group) such as polyacrylic acid (PAA). The negative electrode binder more preferably contains SBR, CMC, and PAA altogether.

Although there is no particular limitation, the content ratio of the binder is preferably 0.5 to 10 parts by mass, more preferably 1 to 8 parts by mass, and still more preferably 2 to 5 parts by mass per 100 parts by mass of the negative electrode active material.

### [Manufacturing Method for Negative Electrode for Secondary Battery]

The negative electrode for a secondary battery disclosed herein can be manufactured by, for example, a manufacturing method including the following steps in this order: the first mixing step (step 1), the second mixing step (step 2), an applying step (step 3), and a pressing step (step 4). The pressing step (step 4) is, however, not essential and can be omitted in another embodiment. The manufacturing method disclosed herein may further include another step at an optional stage. For example, the pressing step (step 4) may be followed by a thermal process step.

The first mixing step (step 1) is a step of mixing (1b) the Si-containing particles and (2) the gap keeping particles, thereby obtaining a first mixture in which the gap keeping particles are disposed around the Si-containing particle. The mixing method is not limited in particular and a conventionally known dry mixing method or wet mixing method can be employed as appropriate. From the viewpoints of convenience, cost effectiveness, and the like, the dry mixing method is preferable. The mixing may be performed using, for example, a stirring granulator, a mortar, a ball mill, a jet mill, a planetary mixer, a disperser, or the like. In a preferred aspect, the first mixture in a powder form is obtained by mixing the Si-containing particles and the gap keeping particles by the dry mixing method.

The second mixing step (step 2) is a step of mixing the first mixture, which is obtained in the first mixing step (step 1), with (1a) the graphite particles, thereby obtaining the negative electrode mixture. The mixing method may be either the same as or different from the method employed in the first mixing step (step 1). In this step, a component other than the graphite particles may be further mixed and contained in the negative electrode mixture. Examples thereof include (3) the conductive material, (4) the binder, the dispersion solvent, and the like. The negative electrode mixture is preferably prepared in a paste form (including a slurry form and an ink form) by containing the dispersion solvent in order to make the coatability excellent in the applying step (step 3) to be described below. In a preferred aspect, this step includes a preliminary paste preparing step (step 21), a preliminary mixing step (step 22), and a paste preparing step (step 23).

The preliminary paste preparing step (step 21) is a step of preparing a paste by mixing the first mixture in the powder form, which is obtained in the first mixing step (step 1), with a predetermined dispersion solvent. The dispersion solvent is not limited in particular and may be an aqueous solvent containing water or a nonaqueous solvent such as N-methyl-2-pyrrolidone (NMP). From the viewpoints of reducing the environment burden, and the like, the dispersion solvent is preferably water or a mixing solvent mainly containing water.

The preliminary mixing step (step 22) is a step of mixing (1a) the graphite particles and (4) the binder in the powder form (for example, CMC or PAA) in a dry procedure, thereby obtaining a second mixture in a powder form. Thus, the uniformity or integrity of the negative electrode active material layer can be improved.

The paste preparing step (step 23) is a step of mixing the first mixture in the paste form obtained in the preliminary paste preparing step (step 21) with the second mixture obtained in the preliminary mixing step (step 22) and here, further adding (3) the conductive material and (4) the binder in a liquid form (for example, SBR), thereby obtaining the negative electrode mixture. In a preferred aspect, the negative electrode mixture is diluted and mixed with the dispersion solvent so as to be prepared in the paste form. The solid content concentration of the paste may be determined as appropriate in accordance with an applying method of the applying step (step 3) or the like, for example.

The applying step (step 3) is a step of applying the negative electrode mixture obtained in the second mixing step (step 2) to the negative electrode current collector. The applying method for the negative electrode mixture is not limited in particular and may be similar to a conventional method. The negative electrode mixture can be applied (typically by coating) on a surface (one surface or both surfaces) of the current collector using a coating device such as a gravure coater, a slit coater, a die coater, a comma coater, or a dip coater. The amount of coating may be determined as appropriate in accordance with the solid content concentration of the negative electrode mixture or the like, for example, so that the negative electrode active material layer has a desired property (thickness or the like). In a case where the negative electrode mixture includes the dispersion solvent, the dispersion solvent is preferably removed by drying the negative electrode mixture. The negative electrode mixture can be dried in accordance with a procedure similar to a conventional one. Thus, the negative electrode mixture including (1a) the graphite particles, (1b) the Si-containing particles, (2) the gap keeping particles, (3) the conductive material, and (4) the binder is fixed to the surface of the negative electrode current collector.

The pressing step (step 4) is a step of pressing the negative electrode mixture on the negative electrode current collector. The pressing method and the pressing conditions are not limited in particular and may be similar to conventional ones. In one example, a pressing machine such as a roll pressing machine can be used. The pressing conditions (for example, pressure, keeping time, and the like) may be set as appropriate so that the negative electrode active material layer has desired properties such as thickness and density. The pressing may be performed at normal temperature or with heat (at high temperature). In this manner, the negative electrode disclosed herein can be manufactured.

### [Secondary Battery]

FIG. 2 is a schematic longitudinal cross-sectional view of a secondary battery 100. As illustrated in FIG. 2, the secondary battery 100 includes a case 10, an electrode body 20, a positive electrode terminal 30, a negative electrode terminal 40, and a nonaqueous electrolyte solution (not illustrated). The secondary battery 100 is a nonaqueous electrolyte solution secondary battery here. The secondary battery 100 is preferably a lithium ion secondary battery. The secondary battery 100 is characterized by including the negative electrode for a secondary battery disclosed herein and other than this characteristic, may be similar to a conventional battery.

The case 10 is a container to accommodate the electrode body 20 and the nonaqueous electrolyte solution. The case 10 here includes a case main body 12 having an opening 12h, and a sealing plate (lid body) 14 to seal the opening 12h. The case 10 is integrated in such a way that the sealing plate 14 is bonded to a periphery of the opening 12h of the case main body 12. The case 10 is hermetically sealed (closed). The sealing plate 14 includes two terminal extraction holes 18 and 19. The terminal extraction holes 18 and 19 penetrate the sealing plate 14.

The positive electrode terminal 30 is electrically connected to a positive electrode tab 23 of the electrode body 20 through a positive electrode current collecting part 50 inside the case 10. The positive electrode terminal 30 is inserted into the terminal extraction hole 18 and extends to the outside from the inside of the sealing plate 14. The positive electrode terminal 30 is disposed at an end part of the sealing plate 14 on one side (left end part in FIG. 2). The positive electrode terminal 30 is here caulked to a peripheral part of the sealing plate 14 that surrounds the terminal extraction hole 18 by a caulking process.

The negative electrode terminal 40 is electrically connected to a negative electrode tab 25 of the electrode body 20 through a negative electrode current collecting part 60 inside the case 10. The negative electrode terminal 40 is inserted into the terminal extraction hole 19 and extends to the outside from the inside of the sealing plate 14. The negative electrode terminal 40 is disposed at an end part of the sealing plate 14 on the other side (right end part in FIG. 2). The negative electrode terminal 40 is here caulked to a peripheral part of the sealing plate 14 that surrounds the terminal extraction hole 19 by the caulking process.

The electrode body 20 is here a wound electrode body in which the positive electrode with a band shape and the negative electrode with a band shape are stacked through a separator with a band shape and wound using a winding axis as a center. The external shape of the electrode body 20 is a flat shape. The electrode body 20 is disposed inside the case 10 with the winding axis extending along a lower surface 12a of the case 10 here. In another embodiment, however, the electrode body 20 may be disposed inside the case 10 with the winding axis extending along a side surface 12b of the case 10. Alternatively, the electrode body 20 may be a multilayer electrode body in which a plurality of square (typically, rectangular) positive electrodes and a plurality of square (typically, rectangular) negative electrodes are stacked in an insulated state. The number of electrode bodies 20 to be disposed inside one case 10 may be one, or two or more (plural).

The structure of the positive electrode is not limited in particular and may be similar to a conventional structure. The positive electrode typically includes a positive electrode current collector and a positive electrode active material layer that is fixed on at least one surface of the positive electrode current collector. At a left end part of the positive electrode current collector, the positive electrode tab 23 is provided and electrically connected to the positive electrode terminal 30 through the positive electrode current collecting part 50. The positive electrode active material layer contains a positive electrode active material. Examples of the positive electrode active material include lithium transition metal complex oxides such as lithium nickel cobalt manganese complex oxide.

The negative electrode includes the negative electrode current collector and the negative electrode active material layer fixed on at least one surface of the negative electrode current collector as described above. At a right end part of the negative electrode current collector, the negative electrode tab 25 is provided and electrically connected to the negative electrode terminal 40 through the negative electrode current collecting part 60.

The nonaqueous electrolyte solution may be similar to a conventional one, without particular limitations. The nonaqueous electrolyte solution typically includes a nonaqueous solvent (organic solvent) and a supporting salt (electrolyte salt). Examples of the nonaqueous solvent include cyclic carbonates such as ethylene carbonate (EC) and monofluoroethylene carbonate (FEC), and chained carbonates such as dimethyl carbonate (DMC) and ethyl methyl carbonate (EMC). Examples of the supporting salt include fluorine-containing lithium salt such as lithium hexafluorophosphate (LiPF₆).

### [Application of Secondary Battery]

The secondary battery 100 can be used in various applications, and suitably used in the application that requires high capacity and a high input-output characteristic, for example, a motive power source (electrical power source for driving) for a motor mounted on a vehicle such as a passenger car or a truck. Although the type of vehicles is not particularly limited, examples thereof may include a plug-in hybrid electric vehicle (PHEV), a hybrid electric vehicle (HEV), a battery electric vehicle (BEV), and the like.

Several test examples relating to the present disclosure will be explained below, but the present disclosure is not meant to be limited to these test examples.

### Test Example I

### [Manufacture of Negative Electrode]

Here, the negative electrodes including the following components in common in the negative electrode active material layer were manufactured.
Negative electrode active material: graphite particles, Si-containing particles (specifically, SiC composite particles)
Conductive material: fibrous carbon (specifically, SWCNT)
Binder: CMC, PAA, SBR

In Example 1, first, the Si-containing particles (SiC composite particles) with the average particle diameter D1 shown in Table 1 and the gap keeping particles (silica, which is the insulating particles and the porous particles) with the average particle diameter D2 shown in Table 1 were mixed in the dry procedure using the stirring granulator, so that the first mixture in which the gap keeping particles were disposed around the SiC composite particle was obtained (first mixing step). Note that in Table 1, mixing the SiC composite particles and the gap keeping particles in advance (in other words, including the first mixing step) is described as “mixing in advance”.

Next, as the second mixing step, the dispersion solvent (water) was first added to the first mixture and the paste was prepared using the disperser (preliminary paste preparing step). Next, the graphite particles, and carboxymethyl cellulose particles (CMC) and polyacrylic acid particles (PAA) as the binder were mixed in the dry procedure using the stirring granulator, so that the second mixture in the powder form was obtained (preliminary mixing step). Subsequently, the second mixture obtained in the preliminary mixing step was mixed with the first mixture in the paste form obtained in the preliminary paste preparing step, and furthermore, fibrous carbon (SWCNT) as the conductive material and the dispersion solvent (water) were added thereto and the mixture was thick-kneaded. Next, styrene butadiene rubber (SBR) as the binder was added, and diluted and mixed with the dispersion solvent (water), so that the negative electrode mixture in the paste form was prepared (paste preparing step).

Note that in the negative electrode mixture, the mixing ratio between the graphite particles and the SiC composite particles was 85:15. The mixing ratio of the other components was gap keeping particles (silica):SWCNT:CMC:PAA:SBR=1:0.1:1:1:1.5 (parts by mass) per the entire amount (100 parts by mass) of the negative electrode active material.

At the time of the thick-kneading described above, the moisture ratio was adjusted as follows in order to cover the periphery of the negative electrode active material with the binder (CMC, PAA). When water was added to a mixed powder body of a determined composition amount of graphite particles and SiC composite particles, the moisture ratio at which the torque necessary for the mixing is maximized is A0%. When the amount of moisture per 100 g of the mixed powder body corresponding to a moisture ratio of A0% is A1 (ml), an ideal solid content ratio B0% that provides the maximum torque is calculated from the following expression:

$$B 0 = 100 - A 0 = 100 / ( 100 + A 1 ) \times 100 ( \% )$$

Next, the negative electrode mixture in the paste form prepared in the paste preparing step was applied on a Cu foil (thickness: 10 μm) as the negative electrode current collector, and dried (applying step). Then, the negative electrode mixture on the negative electrode current collector was pressed to a predetermined thickness so that the negative electrode mixture was densified (pressing step). Then, by processing into a predetermined size, the negative electrode including the negative electrode active material layer on the negative electrode current collector was manufactured.

In Example 2, only some SiC composite particles were “mixed in advance”. Specifically, only 0.8 parts by mass of the SiC composite particles among a total of 1 part by mass of the SiC composite particles was mixed with the gap keeping particles in accordance with the dry procedure in the first mixing step, and the rest 0.2 parts by mass of the SiC composite particles was added together with the graphite particles in the second mixing step. Except this point, the negative electrode was manufactured by a process similar to that in Example 1.

In Comparative Example 1, the negative electrode was manufactured by a process similar to that in Example 1 except that the negative electrode mixture was prepared without adding the gap keeping particles. Specifically, first, the graphite particles, the SiC composite particles, CMC, and PAA were mixed at one time in accordance with the dry procedure using the stirring granulator and then, SWCNT and the dispersion solvent (water) were added thereto and the mixture was thick-kneaded. Next, SBR was added and the mixture was diluted and mixed with the dispersion solvent (water); thus, the negative electrode mixture in the paste form was prepared.

In Comparative Example 2, the negative electrode was manufactured by a process similar to that in Example 1 except that the gap keeping particles were dispersed around the graphite particle in the first mixing step. Specifically, first, the graphite particles and the gap keeping particles were mixed in accordance with the dry procedure using the stirring granulator; thus the first mixture was obtained. Next, the solvent (water) was added to the first mixture and the paste was prepared using the disperser. Subsequently, the SiC composite particles, and CMC and PAA were mixed in accordance with the dry procedure using the stirring granulator; thus the second mixture in the powder form was obtained. Next, the second mixture was mixed with the first mixture in the paste form and furthermore, SWCNT and the dispersion solvent (water) were added thereto and the mixture was thick-kneaded. After that, SBR was added and the mixture was diluted and mixed with the dispersion solvent (water); thus, the negative electrode mixture in the paste form was prepared.

### [Evaluation of Coverage]

For each negative electrode, the coverage a (%) of the graphite particle with the gap keeping particles and the coverage b (%) of the SiC composite particle with the gap keeping particles were calculated as below. That is to say, first, the plurality of graphite particles and SiC composite particles were observed with the scanning electron microscope (SEM) and a SEM image was acquired. Next, the outline of each of the optionally selected graphite particles and SiC composite particles was determined using analysis software. For each particle, the ratio of the total area of parts to which the gap keeping particles adhered to the entire surface area was calculated in percentage. The obtained values were subjected to arithmetic averaging and the coverages a and b were calculated. The results are shown in Table 1.

### [Manufacture of Secondary Battery]

First, the positive electrode was prepared. First, LiNiCoMnO₂ (NCM) as the positive electrode active material, acetylene black (AB) as the conductive material, and PVdF as the binder were mixed in a mass ratio of NCM:AB:PVdF=100:1:1. Next, the fluidity was adjusted with the dispersion solvent (NMP) and the positive electrode mixture in the paste form was prepared. Then, the prepared positive electrode mixture was applied on an Al foil (thickness: 15 μm) as the positive electrode current collector, dried, and pressed to a predetermined thickness. Then, by processing into a predetermined size, the positive electrode including the positive electrode active material layer on the positive electrode current collector was manufactured.

Next, the manufactured positive electrode and negative electrode were disposed facing each other through the separator; thus, the electrode body was manufactured.

Subsequently, the manufactured electrode body was accommodated in a case made of an aluminum laminate sheet, and the nonaqueous electrolyte solution was injected therein. The nonaqueous electrolyte solution was prepared in such a way that LiPF₆ as the supporting salt (Li salt) was dissolved at a concentration of 1.0 mol/L in a mixed solvent in which EC, FEC, EMC, and DMC were mixed so as to satisfy a volume ratio of EC:FEC:EMC:DMC=15:5:40:40. Then, by sealing the opening part of the case, a test cell (laminate cell) was constructed.

### [Evaluation of High-Rate Cycle Characteristic]

First, the test cell was subjected to constant-current charging in a 25° C. environment with a constant current of 1.5 C until a state of charge (SOC) became 50%. Next, after the test cell was kept for an hour in the 25° C. environment, the test cell was subjected to constant-current discharging for 10 seconds with a constant current of 1.0 C. Then, the difference between an open circuit voltage (OCV) and a closed circuit voltage (CCV) at 10 seconds after the discharging was divided by the discharging current value at 10 seconds after the discharging; thus, the initial resistance ((2) was calculated.

$$Initial resistance = ( OC V - CC V ) / discharging current value at 10 seconds from discharging$$

Next, the test cell was subjected to CCCV charging (constant-current charging with a constant current of 1.5 C was performed to 4.2 V and then constant-voltage charging was performed until the current value became 0.1 C) in the 25° C. environment and subsequently, CC discharging (constant-current discharging was performed with a constant current of 0.4 C to 2.5 V) was performed; this cycle was regarded as one cycle and 50 cycles of high-rate charging and discharging were repeated. Subsequently, in the test cell after the high-rate charging and discharging, the resistance after the cycles was measured by a process similar to that of the initial resistance. Then, the ratio of the resistance value after the high-rate charging and discharging to the initial capacity was calculated as a resistance increase rate (%). The results are shown in Table 1.

TABLE 1

| | SiC | Gap keeping particle | | | | | | Battery |
|---|---|---|---|---|---|---|---|---|
| | composite | | | Particle | Addition | | | performance |
| | particle | | | diameter | ratio | | | Resistance |
| | D1 | | D2 | ratio | (parts | Coverage | Manufacturing | increase |
| | (μm) | Kind | (μm) | D2/D1 | by mass) | a/b (*) | method | rate (%) |
| Example 1 | 7 | Silica | 2 | 0.29 | 1 | 0.25 | All mixed in | 103 |
| | | | | | | | advance | |
| Example 2 | 7 | Silica | 2 | 0.29 | 1 | 0.5 | Partially mixed | 105 |
| | | | | | | | in advance | |
| Comparative | 7 | — (None) | | | | — | — | 113 |
| Example 1 | | | | | | | | |
| Comparative | 7 | Silica | 2 | 0.29 | 1 | 2 | Graphite | 111 |
| Example 2 | | | | | | | particles mixed | |
| | | | | | | | in advance | |

(*) a = Coverage (%) of the graphite particle with the gap keeping particles
b = Coverage (%) of the SiC composite particle with the gap keeping particles

As shown in Table 1, the resistance increase rate after the high-rate cycle was the highest in Comparative Example 1 in which the gap keeping particles were not added. It is considered that this is because the repeated expansion and shrinkage of the Si-containing material in the negative electrode along with the charging and discharging resulted in the lack of the electrolyte solution around the Si-containing particles and the liquid shortage was caused. In addition, even if the negative electrode included the gap keeping particles, the resistance increase rate was still high in Comparative Example 2 in which the gap keeping particles did not exist with bias around the SiC composite particle.

In contrast to these Comparative Examples, in Examples 1 and 2 in which the gap keeping particles existed with bias around the SiC composite particle (the ratio (a/b) was less than 1), the resistance increase was small even after the repeated high-rate charging and discharging and the high-rate cycle characteristic was relatively excellent. Thus, the effect of the art disclosed herein has also been proved by the results of the experiments.

### Test Example II: Examination of Ratio (D2/D1) and Addition Ratio of Gap Keeping Particles

In this test example, the negative electrode was manufactured and evaluated by a process similar to that in Example 1 of Test Example 1 except that the average particle diameter D2 of the gap keeping particles, the ratio (D2/D1), and the addition ratio of the gap keeping particles were changed as shown in Table 2. The results are shown in Table 2.

TABLE 2

| | SiC | Gap keeping particle | | | | | | Battery |
|---|---|---|---|---|---|---|---|---|
| | composite | | | Particle | Addition | | | performance |
| | particle | | | diameter | ratio | | | Resistance |
| | D1 | | D2 | ratio | (parts | Coverage | Manufacturing | increase |
| | (μm) | Kind | (μm) | D2/D1 | by mass) | a/b (*) | method | rate (%) |
| Example 1 | 7 | Silica | 2 | 0.29 | 1 | 0.25 | All mixed | 103 |
| Example 3 | 7 | Silica | 3.5 | 0.50 | 3 | 0.25 | in advance | 104 |
| Example 4 | 7 | Silica | 0.7 | 0.10 | 0.1 | 0.25 | | 105 |
| Example 5 | 7 | Silica | 2 | 0.29 | 5 | 0.25 | | 107 |
| Example 6 | 7 | Silica | 7 | 1 | 1 | 0.25 | | 108 |
| Example 7 | 7 | Silica | 0.4 | 0.06 | 1 | 0.25 | | 107 |

(*) a = Coverage (%) of the graphite particle with the gap keeping particles
b = Coverage (%) of the SiC composite particle with the gap keeping particles

As shown in Table 2, the effect of the art disclosed herein can be obtained at least when the ratio (D2/D1) ranges from 0.05 to 1. In Example 6 in which the ratio (D2/D1) was 1 and Example 7 in which the ratio (D2/D1) was 0.06, the resistance increase rate was a little higher than that in Example 1, for example; therefore, it is understood that the ratio (D2/D1) is preferably less than 1 and more preferably 0.1 to 0.5. In addition, the average particle diameter D2 of the gap keeping particles is preferably about 0.1 to 10 μm (for example, 0.4 to 7 μm), more preferably 0.5 to 5 μm, and still more preferably 0.7 to 3.5 μm.

In addition, the results in Example 4 and Example 5 indicate that the effect of the art disclosed herein can be obtained at least when the addition ratio of the gap keeping particles ranges from 0.1 to 5 parts by mass. Moreover, in Example 5 in which the addition ratio of the gap keeping particles was 5 parts by mass, the resistance increase rate was a little higher than that in Example 1, for example; therefore, it is understood that the addition ratio of the gap keeping particles is preferably 4 parts by mass or less and more preferably 3 parts by mass or less.

### Test Example III: Examination of the Kind of Gap Keeping Particles

In this test example, the negative electrode was manufactured by a process similar to that in Example 1 of Test Example 1 except that non-porous alumina was used instead of porous silica as the gap keeping particles. The results are shown in Table 3.

TABLE 3

| | SiC | Gap keeping particle | | | | | | Battery |
|---|---|---|---|---|---|---|---|---|
| | composite | | | Particle | Addition | | | performance |
| | particle | | | diameter | ratio | | | Resistance |
| | D1 | | D2 | ratio | (parts | Coverage | Manufacturing | increase |
| | (μm) | Kind | (μm) | D2/D1 | by mass) | a/b (*) | method | rate (%) |
| Example 1 | 7 | Silica | 2 | 0.29 | 1 | 0.25 | All mixed | 103 |
| | | (porous) | | | | | in advance | |
| Example 8 | 7 | Alumina | 2 | 0.29 | 1 | 0.25 | | 110 |
| | | (non- | | | | | | |
| | | porous) | | | | | | |

(*) a = Coverage (%) of the graphite particle with the gap keeping particles
b = Coverage (%) of the SiC composite particle with the gap keeping particles

As shown in Table 3, using the non-porous particles as the gap keeping particles increased the resistance increase rate a little; thus, it is understood that the gap keeping particles are more preferably the porous particles.

Although the preferable embodiments of the present disclosure have been described above, they are merely examples. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed. For example, another modification can replace a part of the aforementioned embodiment or be added to the aforementioned embodiment. Additionally, the technical feature may be deleted as appropriate unless such a feature is described as an essential element.

As described above, the following items are given as specific aspects of the art disclosed herein.
Item 1: The negative electrode for the secondary battery, including the negative electrode current collector and the negative electrode active material layer fixed to the negative electrode current collector, in which the negative electrode active material layer includes the graphite particles and the Si-containing particles as the negative electrode active material, and the gap keeping particles that exist more around the Si-containing particle than around the graphite particle and keep the gap around the Si-containing particle.
Item 2: The negative electrode for the secondary battery according to Item 1, in which the gap keeping particles include the insulating particle.
Item 3: The negative electrode for the secondary battery according to Item 1 or 2, in which the gap keeping particles include the porous particle.
Item 4: The negative electrode for the secondary battery according to any one of Items 1 to 3, in which the ratio (D2/D1) of the average particle diameter D2 of the gap keeping particles to the average particle diameter D1 of the Si-containing particles is 0.1 or more and 0.5 or less.
Item 5: The negative electrode for the secondary battery according to any one of Items 1 to 4, in which the average particle diameter D2 of the gap keeping particles is 0.5 μm or more and 5 μm or less.
Item 6: The negative electrode for the secondary battery according to any one of Items 1 to 5, in which the content ratio of the gap keeping particles is 0.1 parts by mass or more and 5 parts by mass or less per 100 parts by mass of the negative electrode active material.
Item 7: The negative electrode for the secondary battery according to any one of Items 1 to 6, in which when the coverage of the graphite particle with the gap keeping particles is a and the coverage of the Si-containing particle with the gap keeping particles is b, the ratio (a/b) of the coverage a to the coverage b is 0.25 or more and 0.5 or less.
Item 8: The negative electrode for the secondary battery according to any one of Items 1 to 7, in which the negative electrode active material layer further contains the carbon nanotube as the conductive material.
Item 9: The secondary battery including the electrode body and the nonaqueous electrolyte solution, in which the electrode body includes the negative electrode for the secondary battery according to any one of Items 1 to 8.
Item 10: The manufacturing method for the negative electrode for the secondary battery, including: the first mixing step of mixing the Si-containing particles and the gap keeping particles, thereby obtaining the first mixture in which the gap keeping particles are disposed around the Si-containing particle; the second mixing step of mixing the first mixture with the graphite particles, thereby obtaining the negative electrode mixture; and the applying step of applying the negative electrode mixture on the negative electrode current collector.

What is claimed is:

1. A negative electrode for a secondary battery, comprising a negative electrode current collector and a negative electrode active material layer fixed to the negative electrode current collector, wherein
the negative electrode active material layer includes:
graphite particles and Si-containing particles as a negative electrode active material, and
gap keeping particles that exist more around the Si-containing particle than around the graphite particle and keep a gap around the Si-containing particle.

2. The negative electrode for a secondary battery according to claim 1, wherein the gap keeping particles include an insulating particle.

3. The negative electrode for a secondary battery according to claim 1, wherein the gap keeping particles include a porous particle.

4. The negative electrode for a secondary battery according to claim 1, wherein a ratio (D2/D1) of an average particle diameter D2 of the gap keeping particles to an average particle diameter D1 of the Si-containing particles is 0.1 or more and 0.5 or less.

5. The negative electrode for a secondary battery according to claim 4, wherein the average particle diameter D2 of the gap keeping particles is 0.5 μm or more and 5 μm or less.

6. The negative electrode for a secondary battery according to claim 1, wherein a content ratio of the gap keeping particles is 0.1 parts by mass or more and 5 parts by mass or less per 100 parts by mass of the negative electrode active material.

7. The negative electrode for a secondary battery according to claim 1, wherein when a coverage of the graphite particle with the gap keeping particles is a and a coverage of the Si-containing particle with the gap keeping particles is b, a ratio (a/b) of the coverage a to the coverage b is 0.25 or more and 0.5 or less.

8. The negative electrode for a secondary battery according to claim 1, wherein the negative electrode active material layer further contains carbon nanotube as a conductive material.

9. A secondary battery comprising an electrode body and a nonaqueous electrolyte solution, wherein the electrode body includes the negative electrode for a secondary battery according to claim 1.

10. A manufacturing method for a negative electrode for a secondary battery, comprising:
a first mixing step of mixing Si-containing particles and gap keeping particles, thereby obtaining a first mixture in which the gap keeping particles are disposed around the Si-containing particle;
a second mixing step of mixing the first mixture with graphite particles, thereby obtaining a negative electrode mixture; and
an applying step of applying the negative electrode mixture on a negative electrode current collector.
